(19) United States
(12) Patent Application Publication
(10) Pub. No.: US 2015/0019517 A1
(43) Pub. Date: Jan. 15, 2015

(54) METHOD FOR CONCURRENCY CONTROL IN A DOCBASE MANAGEMENT SYSTEM

(71) Applicant: TIANJIN SURSEN SOFTWARE TECHNOLOGY CO., LTD., Tianjin (CN)

(72) Inventor: Donglin WANG, Tianjin (CN)

(21) Appl. No.: 14/499,727

(22) Filed: Sep. 29, 2014

Related U.S. Application Data
(63) Continuation of application No. PCT/CN2012/075807, filed on May 21, 2012.

(30) Foreign Application Priority Data
Mar. 28, 2012 (CN) 201210084849.2

(51) Int. Cl. G06F 17/30

(52) U.S. Cl. CPC G06F 17/30348; G06F 17/30327; G06F 17/30011; G06F 17/30371
USPC 707/704

(57) ABSTRACT

A method for concurrency control in a docbase management system is provided by an embodiment of the present invention. Document data is stored in a tree structure; the method includes: determining whether an operation instruction on at least one node in the tree structure is compatible with every operation being implemented in the tree structure, when the operation instruction is received; implementing the operation instruction when it is determined that the operation instruction is compatible with the operation being implemented; otherwise, not implementing the operation instruction.

### CROSS-REFERENCE TO RELATED APPLICATION

The application is a continuation of PCT/CN2012/075807 (filed on May 21, 2012), which claims priority of Chinese patent application 201210084849.2 (filed on Mar. 28, 2012), the contents of which are incorporated herein by reference.

### FIELD OF THE INVENTION

The present invention is related to document processing technology, especially related to a method for concurrency control in a docbase management system.

### BACKGROUND OF THE INVENTION

Information is generally divided into structured data and unstructured data, wherein, the unstructured data, which mainly includes text documents and streaming media, statistically shares more than 70%. The structure of the structured data is a fixed bivariate table, which is comparative simple. The structured data is typically processed by a database by using data processing technology. The research and application of the data processing technology are well developed from the 1970s and was flourishing in the 1990s. The unstructured data does not have a fixed data structure; hence it is very complicated to be processed.

Since varieties of software have been widely used to process unstructured documents, there are many different kinds of document formats existing in the prior art. For example, many kinds of software may be used to edit a document in the prior art, such as Microsoft Word, WPS, Yozo soft Office, Red Office, etc. Thus, a piece of content management software usually has to process 200 to 300 kinds of document formats and the document formats may be updating continually, so that it is really difficult to develop such a kind of content management software. Therefore, how to solve problems like lack of a universal document format, inconformity of different access interfaces and high cost of data compatibility have drawn more and more attention.

To achieve document interoperability, management of multiple documents, better document security and better searching functions; a method for document processing (referenced in PCT/CN2006/003296) was proposed by the present applicant. As shown in FIG. 1, software in an application layer issues standard instructions for document processing to a docbase management system, and then the docbase management system performs operations corresponding to the standard instructions on the documents. The documents should conform to a universal document model and the standard instructions are generated by using descriptive methods which are independent to the operation system. Due to this method for document processing, the prior situation that operations from the user interface to that of document storage are all performed by one piece of software has changed, wherein, the functional structure of the software is divided into an application layer and a layer of docbase management system, and an interface standard is set up to regulate the interaction between the two layers. Furthermore, an interface layer which conforms to the interface standard may be included. In this case, the docbase management system is adopted as a universal technical platform with multiple document processing functions. When a document is being processed, instructions are issued by software to the docbase management system via the interface layer, then operations corresponding to the instructions are performed by the docbase management system on the docbase (for example Docbase1.sep2) in the storage. Therefore, as long as software and docbase management systems conform to the same standard, different software can process the same document through the same docbase management system, thus the document interoperability is achieved. Moreover, one piece of software can process different documents through different docbase management systems without independent research and development on every document format.

Besides, a universal document model is provided in the above application. The universal document model can conform to any document to be processed by different kinds of application software. An interface standard is determined based on the document model, so that different kinds of application software can process document through the interface layer. The universal document model also conforms to different kinds of document formats, so that different documents can be operated by one piece of application software through the interface layer. The universal document model includes document sets, document warehouses and libraries, etc; wherein, the document set is composed by documents. The interface standard includes instructions such as organization managing, searching and security controlling for multiple documents. The universal document model further includes pages composed by layers, and the layers are arranged in a top-bottom sequence, in this case, various operation instructions on the layers are also included in the interface standard, as well as storage and extraction instructions of the source files which correspond to one layer of one document. The docbase management system can also manage the information security of the document, such as manage the fine role-based permission and define related operation instructions in the interface standard.

FIG. 2 is an embodiment of a universal document model. As shown in FIG. 2, the universal document model includes document warehouses, docbases, document sets, documents, pages, layers, object groups and layout objects, etc.

The document warehouse includes one or multiple docbases, and the relationship between docbases is relatively loose compared with the substructure of the docbases, so that the docbase management systems can be combined and detached conveniently without any modification on the data of the docbases. Moreover, since there is usually not a unified index (especially full-text index) established between the docbases, each index of the docbases has to be traversed during a searching process in a document warehouse. Each docbase includes one or multiple document sets; and each document set includes one or multiple documents, wherein some sub document sets may be further included in a document set. Those skilled in the art can understand that, the document mentioned above may be any normal document file currently existed (DOC document, for example). The universal document model may stipulate that each document only belongs to one document set or belongs to multiple document sets. A docbase is not a simple combination of multiple documents, it organizes multiple documents closely especially by establishing various unified indexes, which brings greater convenience for searching document content.

Each document includes one page or multiple ranked (from front to back) pages, and the type area of each page may be different, which may be in any shape expressed by one or multiple closed curves and not limited to a rectangular shape.

Each page includes one or multiple ranked (from top to bottom) layers, and one layer is superposed on another sequentially like superimposed glass boards. The layer includes layout objects and object groups, wherein, the layout object includes status (such as font, font size, color, ROP, etc.), texts (including symbols), graphics (such as straight line, curve, closed area filled with appointed color, gradient color, etc.), images (such as TIF, JPEG, BMP, JBIG, etc.), semantic information (such as title beginning, title ending, new line, etc.), source files, scripts, plug-ins, embedded objects, bookmarks, links, streaming media and binary data flow, etc., wherein, one or multiple layout objects may be combined to form an object group, and an object group may further includes sub object groups.

Each of the docbase, document set, document, page and layer may further includes metadata (such as title, last modified time, etc., the type of which may be set to meet the application requirements) and/or historical operation records; the document may further include navigation information, introduction information and miniature layout; however the miniature layout may be included in the page or in the layer in some circumstances; furthermore, each of the docbase management system, document set, document, page, layer and objects group may also include a digital signature; Semantic information is usually included in the layout information, so that data redundancy can be avoided and a relationship with the layout can be easily established; fonts, images and other shared resources may be contained in the docbase and the document.

FIG. 3 is an embodiment of a document processing system based on the document processing technology mentioned above. Application software issues an operation on a document via a unified interface standard (for example: the interface of unstructured operation markup language (UOML)). Different types of docbase management systems developed by different manufacturers are accordant with the same interface standard. In this case, different application software such as Red Office, Optical Character Recognition, Web generating software, Musical score editing software, Sursen reader, Office editing software, etc., can issue the operation request to the docbase management systems via the UOML interface and there may be multiple docbase management systems as shown in FIG. 2 indicated as docbase management system 1, 2, 3 respectively. The docbase management system operates on the documents conforming to the universal model based on the unified UOML standard instruction, such as creating, saving, displaying and presenting the document.

In above technical scheme of document processing provided by the applicant, the same docbase management system may be invoked by different application software at the same time or at different time, and different docbase management systems may be invoked by the same application software at the same time or at different time. However, there is not a technical scheme for concurrency control during operating on the universal document model provided in this filed.

### SUMMARY OF THE INVENTION

A method for concurrency control in a docbase management system is provided by an embodiment of the present invention, which can effectively control concurrency operations of a document model with a tree structure in a docbase management system.

A method for concurrency control in a docbase management system is provided by an embodiment of the present invention, wherein, document data is stored in a tree structure; the method includes:

determining whether an operation instruction on at least one node in the tree structure is compatible with each operation being implemented when the operation instruction is received;

implementing the operation instruction when it is determined that the operation instruction is compatible with the operation being implemented; otherwise, not implementing the operation instruction.

The method for concurrency control provided by the present invention is applicable for any kind of docbase management system, as long as the internal data of the docbase management system can be mapped to a tree structure model. The feasibility of the concurrently controlling is high and high system performance with accuracy is achieved.

### BRIEF DESCRIPTION OF THE DRAWINGS

FIG. 1 illustrates a structure of a document processing system in the prior art.

FIG. 2 illustrates a structure of a universal model of documents in the prior art.

FIG. 3 illustrates a structure of a document processing system in the prior art.

FIG. 4 illustrates a flow chart of a concurrency control process in an embodiment of the present invention.

FIG. 5 illustrates a flow chart of a concurrency control process in an embodiment of the present invention.

FIG. 6 illustrates a flow chart of a process for acquiring a lock in an embodiment of the present invention.

FIG. 7 illustrates a flow chart of a process for releasing a lock in an embodiment of the present invention.

FIG. 8 illustrates a structure of mapping data of a docbase management system to a tree structure module in an embodiment of the present invention.

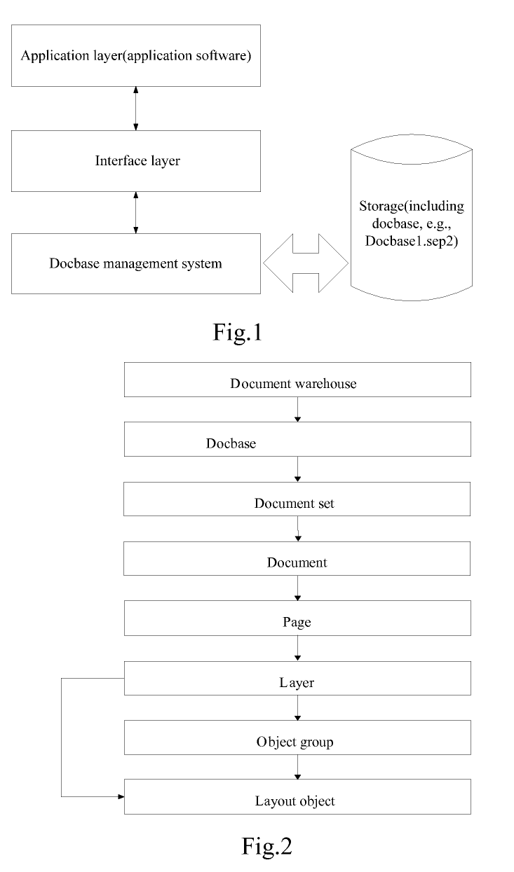

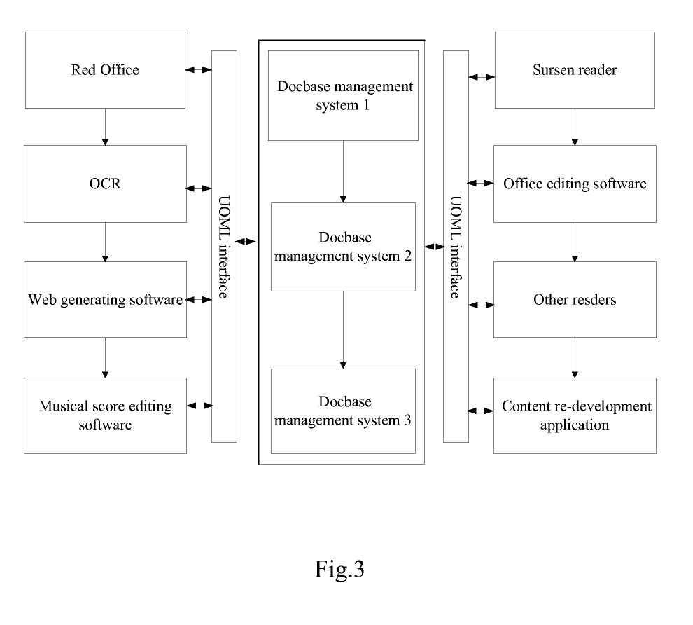

### DETAILED DESCRIPTION OF THE INVENTION

The present invention is described more fully herein with reference to the accompanying drawings and embodiments, those skilled in the art should understand, the above embodiments are used barely for clarity and not as limitation to the present invention.

A method for concurrency control is provided by an embodiment of the present invention. In the embodiment, document data is stored in a tree structure; the method includes: determining whether an operation instruction on at least one node in the tree structure is compatible with every operation being implemented in the tree structure, when the operation instruction is received; implementing the operation instruction when it is determined that the operation instruction is compatible with the operation being implemented; otherwise, not implementing the operation instruction.

In the embodiment, determining whether an operation instruction on at least one node in the tree structure is compatible with every operation being implemented in the tree structure includes: determining whether the operation instruction on a current node is compatible with every operation being implemented on its father node, ancestor nodes, son nodes and grandson nodes.

In an embodiment of the present invention, whether the operation instruction of the current node is compatible with every operations being implemented on its father node and ancestor nodes is determined by a preset compatibility matrix. The compatibility matrix may record: 1) whether the operation instruction for any of reading, writing and deleting on the current node is compatible with any of reading, writing and deleting operation being implemented on the current node, herein, the operation instruction for reading is compatible with the reading operation being implemented, and other operations are not compatible with each other; 2) whether the operation instruction for any of reading, writing and deleting on the current node is compatible with any of reading, writing and deleting operation being implemented on its father node, herein, the operation instruction for reading is compatible with the reading or writing operation being implemented on its father node, and other operations are not compatible with each other; 3) whether the operation instruction for any of reading, writing and deleting on the current node is compatible with any of reading, writing and deleting operation being implemented on its ancestor nodes, herein, the operation instruction for any of reading, writing, and deleting is not compatible with the deleting operation being implemented on its ancestor node, and other operations are compatible with each other.

In an embodiment of the present invention, three compatibility matrixes are provided, which includes: a compatibility matrix of the current node, a compatibility matrix of the current node and its father node, a compatibility matrix of the current node and its ancestor nodes, the three compatibility matrixes are shown in below tables:

a) The compatibility matrix of the current node is shown in Table. 1:

TABLE 1

| | reading op- | writing op- | deleting op- |
|---|---|---|---|
| | eration on the | eration on the | eration on the |
| | current node | current node | current node |
| reading operation | ✓ | x | x |
| on the current node | | | |
| writing operation | x | x | x |
| on the current node | | | |
| deleting operation | x | x | x |
| on the current node | | | |

b) The compatibility matrix of the current node and its father node is shown in Table. 2:

TABLE 2

| | reading op- | writing op- | deleting op- |
|---|---|---|---|
| | eration on the | eration on the | eration on the |
| | father node | father node | father node |
| reading operation | ✓ | ✓ | x |
| on the current node | | | |
| writing operation | ✓ | ✓ | x |
| on the current node | | | |
| deleting operation | x | x | x |
| on the current node | | | |

c) The compatibility matrix of the current node and its ancestor nodes is shown in Table. 3:

TABLE 3

| | reading op- | writing op- | deleting op- |
|---|---|---|---|
| | eration on its | eration on its | eration on its |
| | ancestor nodes | ancestor nodes | ancestor nodes |
| reading operation | ✓ | ✓ | x |
| on the current node | | | |
| writing operation | ✓ | ✓ | x |
| on the current node | | | |
| deleting operation | ✓ | ✓ | x |
| on the current node | | | |

In above compatibility matrixes, “✓” represents as compatible, and “x” represents as not compatible.

By regarding the current node as a father node or an ancestor node, the compatibility determination between the operation instructions of the current node and the operations on its son nodes and grandson nodes is similar with that between the operation instructions of the current node and the operations on its father node and ancestor node.

The compatibility matrixes mentioned above are only examples, which cannot be used to limit the protection scope of the present invention. Within the same or similar principle, those skilled in the art may develop other forms of matrixes.

Other methods may be used to determine the compatibility between the operation instructions to be implemented and operations being implemented in the tree structure. For example, as long as there is a node being operated in the paths from the root node to the current node and its son nodes, the operation instructions to be implemented are determined as incompatible with the operations being implemented; in this case, the concurrent operating efficiency may be reduced as compatible operations may not be operated concurrently; the operating accuracy will not be affected. Or if a deleting operation is being implemented on a node, any operations on its son node may be considered compatible; in this case, although the son node may also be deleted to result in a failure operation as the son node would not exist; the concurrent operating accuracy will also not be affected.

In an embodiment of the present invention, the three operations mentioned above may be further divided to make the compatibility determination more accurate and make the concurrency control more efficient. For example, the writing operation may be further divided into an attribute writing operation, a writing operation on node data, etc. In this case, although the writing operation on the current node is incompatible with the deleting operation on its son nodes, the attribute writing operation on the current node is compatible with the deleting operations on its son nodes.

In another embodiment of the present invention, incompatible operations are prevented from being implemented by a lock mechanism. The details of the lock mechanism are shown in following embodiments.

In an embodiment of the present invention, a lock of a node on which a operation instruction to be implemented is acquired only when the operation instruction is compatible with every operation being implemented in the system; and only when the lock has been acquired (locked), the operation instruction can be implemented on the node by the docbase management system; after the operation instruction is implemented, the lock is released (unlocked).

In an embodiment of the present invention, to prevent operation status from being modified repeatedly, a status lock is acquired before querying/modifying the operation status of a node, and then the process includes: acquiring a status lock of the node, determining whether the operation instruction is compatible with every operation being implemented; releasing (unlocking) the status lock if it is not compatible and terminating the process; or, recording the operation status of the node, releasing the status lock, implementing the operation instruction, acquiring the status lock, restoring the operation status of the node and releasing (unlocking) the status lock.

In another embodiment of the present invention, whether the operation instruction is compatible with every operation being implemented in a tree structure is determined by using the data structure of concurrency control data of the tree structure. Herein, the tree structure is mapped from document data.

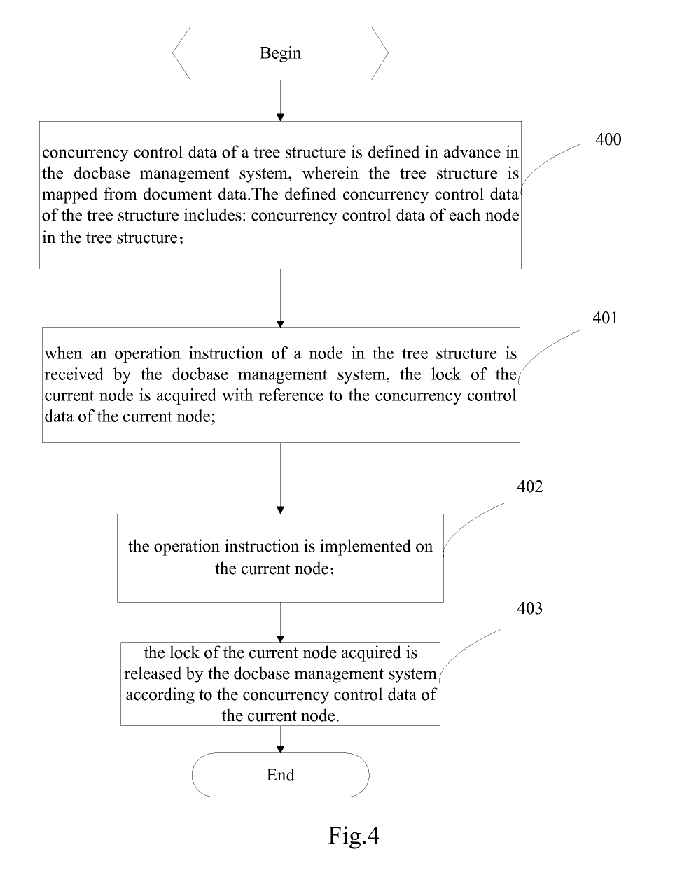

FIG. 4 illustrates the flow chart of a concurrency control process in an embodiment of the present invention, as shown in FIG. 4, the concurrency control process includes:

Step 400: concurrency control data of a tree structure is defined in advance in the docbase management system, wherein the tree structure is mapped from document data. In this case, as long as a docbase management system can map the document data into a data model with tree structure, it can use the concurrency control method in this embodiment. The defined concurrency control data of the tree structure includes: concurrency control data of each node in the tree structure.

Step 401: when an operation instruction of a node in the tree structure is received by the docbase management system, the lock of the current node (the node appointed by the operation instruction) is acquired with reference to the concurrency control data of the current node. It should be noticed that, among the operation instructions of a certain node at a certain time, only one of incompatible operations can acquire the lock. That is to say, the lock can't be occupied by more than one incompatible operation instructions of the certain node at the same time. For example, in this step, when the lock of node A has been acquired by a writing operation instruction (i.e., the writing operation has not been completed), it cannot be re-acquired by a reading operation instruction; However, if the lock of node A has been acquired by a reading operation instruction, it can still be acquired by another reading operation instruction. Herein, the lock may be provided by the operation system or any other mechanism realized by the developer, such as: a spinlock, mutual repulsion, signal light, etc., which is not limited by the present invention.

Step 402: after successfully acquiring the lock of the current node in Step 401, the operation instruction is implemented on the current node. The operation may include: reading, writing, deleting and so on.

Step 403: the lock of the current node acquired in Step 401 is released by the docbase management system according to the concurrency control data of the current node, and the process is ended.

In the above embodiment of the present invention, by using lock mechanism, different operations of the same node would not be implemented simultaneously by the docbase management system, so that concurrency control of operations on a node is achieved effectively.

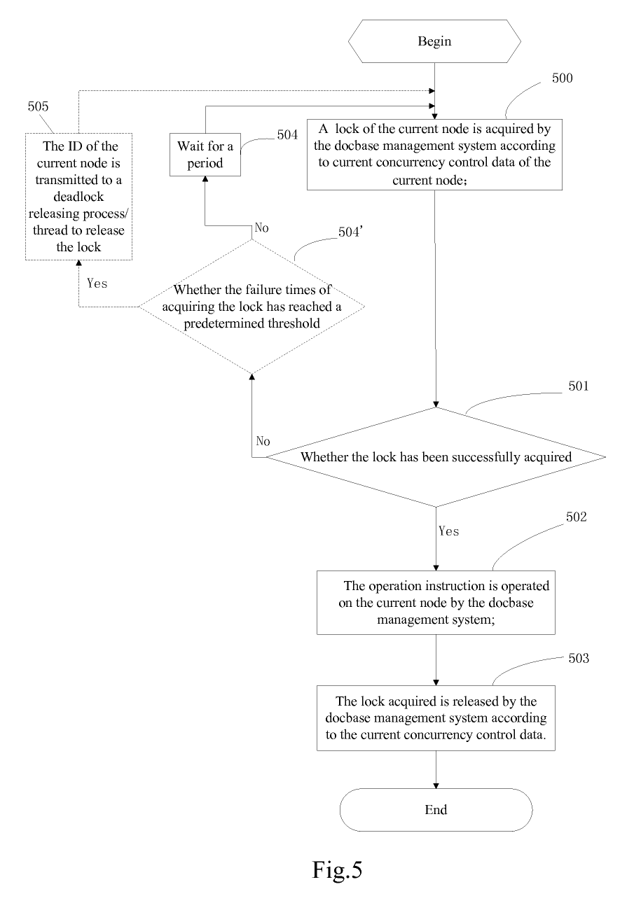

FIG. 5 illustrates a flow chart of a concurrency control process in another embodiment of the present invention. As shown in FIG. 5, after the concurrency control data is defined by the docbase management system as described in Step 400, following steps may be implemented when an operation instruction on a current node is received.

Step 500: a lock of the current node (the node appointed by the operation instruction) is acquired by the docbase management system according to current concurrency control data of the current node.

Step 501: whether the lock has been successfully acquired is determined by the docbase management system. If it has been successfully acquired, continue with Step 502; otherwise, continue with Step 504.

Step 502: the operation instruction is operated on the current node by the docbase management system.

Step 503: the lock acquired in Step 500 is released by the docbase management system according to the current concurrency control data, and the process is ended.

Step 504: after a certain period of waiting, the docbase management system tries to acquire the lock again, i.e., return to Step 500.

In the above process, when the lock is not successfully acquired by the operation instruction, it will be acquired again after a certain period of waiting. If the lock is then released by other operation instructions, it can be acquired by the operation instruction successfully now. Of course, according to the practical situation, if the lock cannot be successfully acquired, the process may be directly ended without waiting, which means the operation instruction fails.

In order to avoid a deadlock, a deadlock releasing process/thread may be further applied to release the lock occupied by sessions which does not respond in the docbase management system. Specifically, each operation instruction corresponds to a session, and there are usually multiple sessions in a docbase management system at the same time and one or multiple operation instructions may be operated in each session. When there is an abnormal situation occurred during a session, some operation instructions in this session may not be operated normally; the session may become unresponsive and unable to be released. In this case, the lock of the node held by this session will not be released normally, so that it also cannot be acquired by other operation instructions, which will result in a deadlock. It should be noticed that: a session refers to a process from the establishment of a connection between a client and a docbase management system to the end of the connection; in one session, one or multiple operation instructions may be sent to the docbase management system by an application via an interface, and the docbase management system may handle multiple sessions from multiple applications at the same time, so the docbase management system need to deal with multiple operation instructions concurrently sent by multiple applications. The present invention is exactly provided to a scheme to achieve concurrent control of those concurrently implemented operation instructions in the docbase management system.

Considering the above situation, the process shown in FIG. 5 may further include Step 504′ and Step 505. Step 504′ will be implemented when the lock is not acquired in Step 501. In Step 504′, the docbase management system determines whether the failure times of acquiring the lock has reached a predetermined threshold. If it has not reached, continue with Step 504; otherwise, continue with Step 505. In Step 505, the ID of the node is transmitted to the deadlock releasing process/thread by a process/thread used to acquire the lock, and then the process is turned to step 500 to try to acquire the lock again after the lock is released by the deadlock releasing process/thread.

The principle of the deadlock releasing process/thread is further described in detail as follows.

1. The main functions of the deadlock releasing process/thread include at least one of follows:

a) The deadlock releasing process/thread scans each existing session in the system, determines sessions which are not responsive, releases those sessions unresponsive and releases the locks held by those sessions unresponsive. The deadlock releasing process/thread could be activated at regular time (according to a predetermined time or period) or activated manually by the user.

b) The deadlock releasing process/thread can receive and respond the information from other processes/threads (such as processes/threads for acquiring a lock), scan a session holding a lock appointed by the information and determine whether the session is unresponsive. When the result returns “yes”, the session is released and the lock appointed by the information is further released as well.

2. The following method is applied by the deadlock releasing process/thread to determine whether a session is unresponsive.

The deadlock releasing process/thread monitors implementing time of every operation instruction in each session. When the implementing time of an operation instruction in a session is beyond a preset threshold, the session is considered as unresponsive.

It should be noticed that, a variety of functions may be provided to a client by the docbase management system via interfaces. Therefore, when a session in the docbase management system is busy, it must be occupied by operation instructions (such as: operation instructions on a certain node) issued by the client via interfaces, and the processing time of each interface is not very long. Thus, a time threshold may be preset for each interface as a characteristic value of implementing time of an operation instruction. In each session, after receiving an operation instruction and successfully acquiring the lock of the node corresponding to the operation instruction, information related to the operation instruction will be recorded in a common data structure before the instruction operation is implemented. The information recorded includes: the current time, ID of the current session, name of the corresponding interface, the information of the lock acquired by the operation instruction, etc. The information will be cleared after the operation instruction is implemented. When the time spent by a session on implementing an operation instruction is beyond a time threshold preset for the interface corresponding to the operation instruction, the session is determined as unresponsive.

The following is detail description of the methods for acquiring and releasing a lock in FIG. 4 and FIG. 5.

The two processes of acquiring and releasing a lock respectively are defined based on the data structure of the above concurrency control data.

The concurrency control data of each node in the tree structure specifically includes:

a) Operating status, which includes: reading status, writing status and deleting status. The operations of concurrency control refer to operations on nodes in the tree structure, which includes: reading, writing and deleting operations. Herein, the reading operations mean reading the data of the current node, the writing operations mean writing data to the current node or creating son nodes of the current node, and the deleting operations mean deleting the current node. In an embodiment of the present invention, an operation of deleting the son nodes of the current node includes: an operation of deleting the son nodes and a writing operation on the current node.

b) Count of reading operations, used to count the times of the reading operations being implemented on a current node. The counting process may be achieved via a counter. Every time a reading operation is implemented on the current node, the counter adds one to its count of reading operations; and every time a reading operation is finished, the count of reading operations of this counter minus one.

c) Count of operations on son nodes, used to count the times of operations being implemented on son nodes of the current node. The counting process may be achieved by using a counter. Every time an operation is implemented on the current node, the counts of counters in the concurrency control data of its father node and ancestor nodes add one respectively; and every time an operation is finished, the counts of those counters minus one respectively. The ancestor nodes refer to nodes in the path from the current node to the root node of the tree structure except for the current node and its father node.

In another embodiment of the present invention, the defined concurrency control data of the tree structure further includes global concurrency control data, and then the lock of the current node (the node appointed by the operation instruction) is acquired by the docbase management system according to the global concurrency control data and the concurrency control data of the current node.

The global concurrency control data, for all the nodes in the tree structure, includes:

a) Concurrency control data of each node in the tree structure, which may be represented as a list and includes: identifications (ID) and concurrency control data of all the nodes in the tree structure respectively. By using the list, the concurrency control data of the current node can be quickly found according to its ID. The list may apply any data structure in the prior art, such as: hash table, red-black tree, etc.

b) A global lock, used to control the access to the list described in a). The global lock may apply any mechanism provided by the operation system or realized by developers, such as: spin lock, mutual repulsion, signal light, etc., and the form of the global lock cannot be used to limit the protection scope of the present invention.

Secondly, the process for acquiring a lock may be defined as follows:

Process name: lock_node;

Input: IDs of the current node (i.e., the node appointed by an operation instruction), its father node and ancestor nodes; an operation (reading, writing, or deleting) on the current node;

Return value: success/failure.

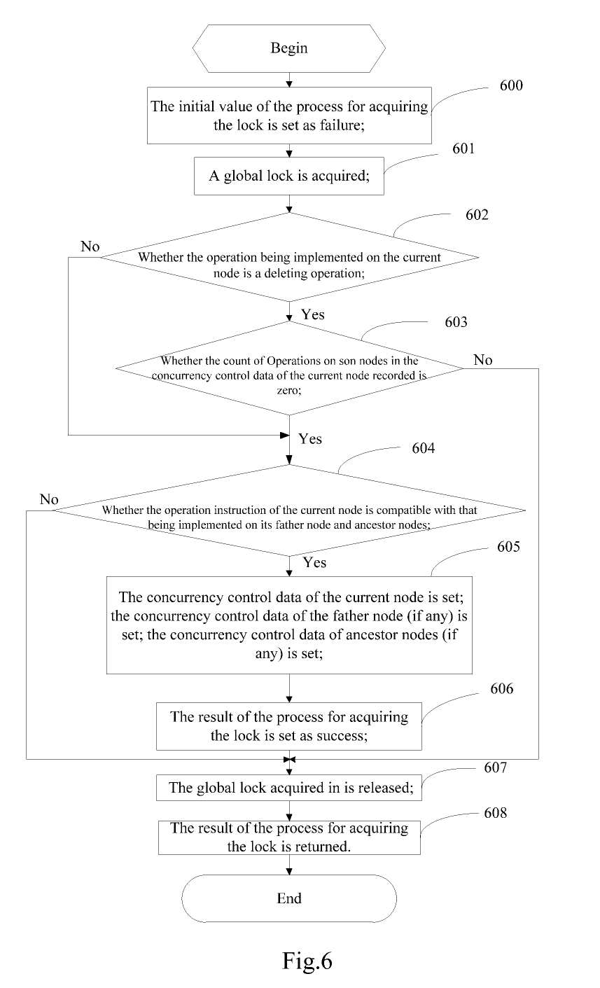

Steps: as shown in FIG. 6.

Thirdly, the process for releasing a lock may be defined as follows:

Process name: unlock_node

Input: IDs of the current node (i.e., the node appointed by an operation instruction), its father node and ancestor nodes; an operation (reading, writing, or deleting) on the current node;

Return value: null

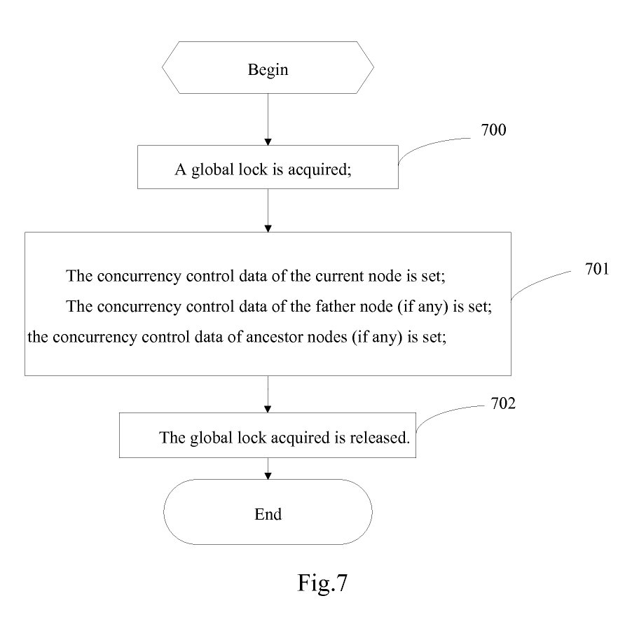

Steps: as shown in FIG. 7

FIG. 6 illustrates a flow chart of a process for acquiring a lock in an embodiment of the present invention, as shown in FIG. 6, the process includes:

Step 600: a process for acquiring a lock is invoked according to an operation instruction. IDs of the current node, its father node and ancestor nodes, and value of the operation on the current node are assigned to the inputs of the process for acquiring the lock, so that an instance of the process for acquiring the lock is established. The initial value of the process for acquiring the lock is set up as failed firstly.

Step 601: a global lock is acquired.

Step 602: whether the operation being implemented on the current node is a deleting operation is determined Continue with Step 603 if it is; otherwise, continue with Step 604.

Step 603: whether the count of operations on son nodes in the concurrency control data of the current node is zero is determined Continue with Step 604 when it is zero; otherwise, continue with Step 607.

Step 604: whether the operation instruction of the current node is compatible with operations being implemented on its father node and ancestor nodes is determined When it is compatible, continue with Step 605; otherwise, continue with Step 607. Herein, when the operation instruction of the current node is not compatible with any operation being implemented on its father node and ancestor nodes, it is determined that the operation instruction of the current node is not compatible with all of the operations being implemented on its father node and ancestor nodes.

Step 605:

1. The concurrency control data of the current node is set as follows:

a) The operating status is set as an operation (writing, reading or deleting) appointed by the operation instruction, i.e., the operation from the input of the process for acquiring the lock;

b) If the operation being implemented on the current node is a reading operation, the count of reading operations adds one.

2. If the current node has father node, then the concurrency control data of the father node is set as follows:

a) If the operation being implemented on the current node is a deleting operation, the operating status recorded in the concurrency control data of the father node is updated as a writing operation;

b) The count of operations on son nodes recorded in the concurrency control data of the father node adds one.

3. If the current node has one or multiple ancestor nodes, the concurrency control data of each ancestor node is set; specifically, the count of operations on son nodes recorded in the concurrency control data of each ancestor node adds one.

Step 606: the result of the process for acquiring the lock is set as success.

Step 607: the global lock acquired in Step 601 is released.

Step 608: the result of the process for acquiring the lock is returned as success or failure, and process is ended.

FIG. 7 illustrates a flow chart of a process for releasing a lock in an embodiment of the present invention. As shown in FIG. 7, the process includes following steps.

Step 700: a process for releasing a lock is invoked according to an operation instruction. IDs of the current node, its father node and ancestor nodes, and the value of the operation on the current node are assigned to the input of the process for releasing the lock, so that an instance of the process for acquiring the lock is established. A global lock is acquired firstly.

Step 701:

1. The concurrency control data of the current node is set as follows:

a) If the operating status is a writing operation or a deleting operation, the operating status is cleared.

b) If the operating status is a reading operation, the count of reading operations minus one. The operating status is cleared when the count of reading operations becomes zero.

2. If the current node has father node, the concurrency control data of the father node is set as follows:

a) When the operation on the current node is a deleting operation, the operating status recorded in the concurrency control data of the father node is cleared;

b) The count of operations on son nodes recorded in the concurrency control data of the father node minus one.

3. If the current node has one or multiple ancestor nodes, the concurrency control data of each ancestor node is set, specifically, the count of operations on son nodes recorded in the concurrency control data of each ancestor node minus one.

Step 702: the global lock acquired in step 700 is released, and the process is ended.

With reference to the above content, the method for sending information/messages from a process/thread for acquiring a lock to the deadlock releasing process/thread is described additionally as follows:

In an embodiment of the present invention, the primitive of locking a single node is “lock_node” (the process for acquiring a lock); when a “lock_node” process has been invoked by a certain session, if the node to be operated is locked by other sessions, which means the lock is occupied by other sessions, the “lock_node” process would immediately return a failure result. When the current session fails to acquire the lock by using the primitive “lock_node”, the lock may be acquired again after a period of waiting. When the failure times of acquiring the lock exceeds a preset threshold, a message is sent to the deadlock releasing process/thread to specify the ID of the node which lock is not acquired. The deadlock releasing process/thread determines whether the session is unresponsive with reference to the node ID. When the session is determined as unresponsive, the session unresponsive is released and the corresponding lock is further released as well. In this way, the lock may acquire successfully by another acquiring process. The session which fails to acquire the lock before, may turn to a sleep state firstly and then try to acquire the same lock again by using the primitive “lock_node”.

In addition, since some operation instructions may be implemented on multiple nodes, multiple locks corresponding to the nodes should be acquired firstly, and then the operations are implemented on the nodes, and finally the multiple locks are released. During the lock acquiring process, the multiple locks may be acquired in sequence.

In the docbase management system, the process for acquiring/releasing multiple locks is pre-defined as follows with reference to the process for acquiring/releasing a single lock.

1. The process for acquiring multiple locks may be defined as follows:

Process name: lock_node_multi;

Input: the IDs of the multiple nodes, their respective paths (i.e. the father node and ancestor nodes of each node), the operation instructions on each node;

Return value: null

Steps:

1) The multiple nodes are ranked according to the sequence set by the docbase management system;

2) The lock of each node is acquired in turn by using the primitive “lock_node” (as illustrated in FIG. 6 and will not be described again here).

In the above defining process, new content may be further added to the input to meet specific requirements, such as the number of the multiple nodes, etc.

In Step 2), when it fails to acquire one lock, the lock may be acquired again after a sleeping time until the lock is acquired successfully. Furthermore, if the failure times of acquiring one lock by using the primitive “lock_node” exceed a preset threshold, a message is sent to the deadlock releasing process/thread to specify the ID of the node which lock is not acquired. The deadlock releasing process/thread determines whether the session of the lock is unresponsive according to the node ID. If the session is determined as unresponsive, the unresponsive session is released and the corresponding lock is further released as well. In this way, the lock may be acquired successfully by another acquiring process. The session which fails to acquire the lock before, may turn to a sleep state firstly and then try to acquire the same lock again by using the primitive “lock_node”.

2. The process for releasing multiple locks may be defined as follows:

Process name: unlock_node_multi;

Input: IDs of the multiple nodes, their respective paths (i.e. the father node and ancestor nodes of each node), the operation instructions on each node;

Steps:

1) The multiple nodes are ranked according to the sequence set by the docbase management system;

2) The lock of each node is released in turn by using the primitive “unlock_node” (as illustrated in FIG. 7 and will not be described again here).

In the above defining process, new content may be further added to the input to meet specific requirements, such as the number of the multiple nodes, etc.

The multiple nodes are ranked by the docbase management system in a total order, which means, any two nodes could be ranked in a consistent sequence, and this sequence should have transitivity. For instance, if node A is before node B and node B is before node C, node A must be before node C. Three ranking examples are given as follows.

1. The multiple nodes are ranked according to their ID numbers. Since the ID numbers of the multiple nodes are integers, a total order could be achieved by ranking the ID numbers.

2. The entire tree structure may include multiple sub trees; multiple nodes in the same sub tree are ranked according to their ID numbers; the order of different sub trees is ranked according to the features and semantics of the sub trees. For example, a role sub tree is the priority, followed by an Access Control List (ACL) sub tree, and a directory/document sub tree is last. Herein, the role sub tree and ACL sub tree are auxiliary objects of the directory/document sub tree. The nodes of the directory/document sub tree correspond to the document data. The nodes of the role sub tree and ACL sub tree correspond to security operating data of the document data (such as roles and permissions). The nodes of the role sub tree and ACL sub tree could be mapped to obtain operation permissions and roles of document data of one node of the directory/document sub tree. The concepts of the role sub tree, ACL sub tree and directory/document sub tree could be found in other patent applications of the applicant and will not be described herein.

3. The entire tree structure includes multiple sub trees; the order of different sub trees is ranked in the same way described in method 2. However, nodes in the same sub tree are ranked by the sequence from root to leaf (i.e., are ranked according to the depth of the nodes); the multiple nodes in different paths are ranked according to their ID numbers.

It should be explained that, a variety of ranking methods may be used by the docbase management system as long as a total order is achieved, and the ranking methods can't be used to limit the protection scope of the present invention. One docbase management system only applies one ranking method. The docbase management system may provide a configuration option to let a user to choose one from different ranking methods supported by the docbase management system. Besides the process for acquiring multiple locks, the method for implementing operation instructions on multiple nodes is also generally the same with that on single node, which will not be further described herein.

In an embodiment of the present invention, the mapping from data of the docbase management system to an abstract tree structure is illustrated as follows:

1. The data types of the docbase management system include:

a) Directory (document set);

b) Document;

c) Data parts consisted of the document (such as: pages of the document, each of which could be stored respectively), which is also called as data segments below;

d) ACL data, each of which corresponds to a document or directory, is used to describe permissions of the document or directory, and could be a list;

e) Multiple permissions of the ACL data, each of which is used to describe a permission on the document/directory of a certain role; and does not have son nodes, i.e., they are leaf nodes of the tree structure;

f) Role data, each of which corresponds to a role in the docbase management system.

2. Types of the nodes in an abstract tree structure are defined as follows.

a) There are two types of nodes: a container and flow;

b) The container may include a number of son nodes which is not limited and the son nodes may be containers or flows. The container may have their own data or not; while the flow does not have a son node (leaf node) and only has their own data;

c) The root node and internal nodes are containers, and leaf nodes are containers or flows;

d) Each node has its unique ID.

3. The mapping from data of the docbase management system to the abstract tree structure is defined as follows.

a) A directory is mapped to a container;

b) A document is mapped to a container or a flow;

c) A data segment of the document (such as a page, layer, version object, etc.) is mapped to a container or a flow;

d) The root node of a document/directory structure, as the root directory of the docbase management system, is mapped to a container;

e) ACL data is mapped to a container or a flow; the ACL permission is mapped to a flow; a list of ACL data (i.e. the root node of the ACL tree) is mapped to a container;

f) Role data is mapped to a flow; the list of all the roles (the root node of the role tree) is mapped to a container.

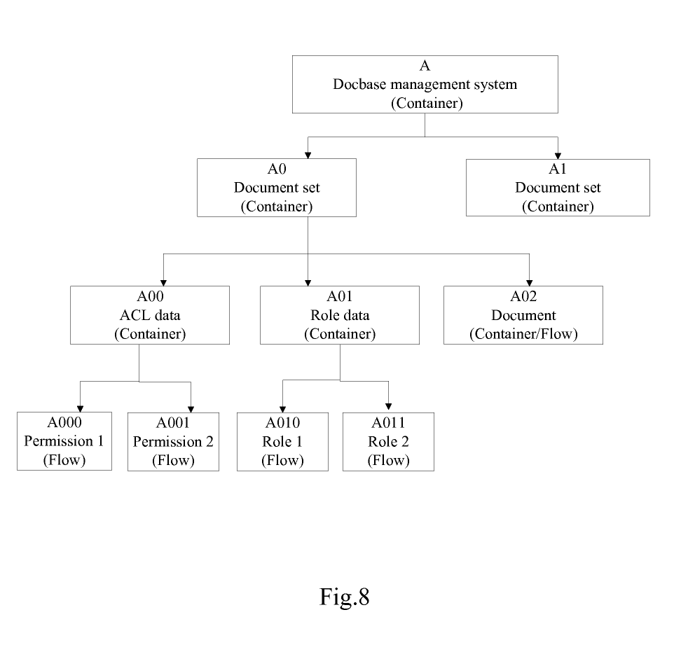

FIG. 8 illustrates a flow chart of mapping data of a docbase management system to a tree structure in an embodiment of the present invention. As shown in FIG. 8, an abstract tree structure consisting of containers and flows and acquired through a mapping process is illustrated. For example, node A, which is the root directory of the docbase management system, i.e., is the root node of the tree structure, is a container; the son nodes A0 and A1 of node A are both document sets and used as containers; the sub tree which root node is node A1 has not been shown in FIG. 8 and represented by ellipsis; son nodes A00, A01, A02 of node A0 are ACL data and used as containers; node A01 is role data and used as a container; node A02 is a document and used as a container or a flow; node A02 has no son node; son nodes A000, A001 of node A00 are permission 1 and permission 2 respectively, and both of them are used as flows; son nodes A010, A011 of node A01 are role 1 and role 2 respectively, and both of them are all used as flows.

The mapping method described above is just an example. Whether a document is separated into data segments, whether a data segment is further separated and whether ACL data is separated into permissions could be flexibly chosen during a mapping process. The mapping methods and their modifications should not be used to limit the protection scope of the present invention. Regardless of which mapping method is used, the method for concurrency control in the embodiments of the present invention can be applied on the abstract tree structure which consists of containers and flows.

The method for concurrency control provided by the present invention is applicable for any kind of docbase management system as long as the internal data can be mapped to a tree structure model. The feasibility of concurrently control is high so that high system performance can be achieved with ensuring the operation accuracy. When the path length of a node to be operated is indicated as “n”, the complexity of the algorithm is “O(n)”, which can be applied to a large scaled tree structure. In addition, data module which could be used by most of docbase management system is modeled by the method for concurrency control provided by the present invention, which could be applied widely and is easy to be improved. The method could be achieved on a variety of platforms. Besides plane documents, the method can be applied to any unstructured data of application/software platforms, as long as the data could be mapped to a tree structure.

The above embodiments are only preferred embodiments of the present invention and cannot be used to limit the protection scope of the present invention. Those skilled in the art can understand that, the technical scheme of the embodiment may still be modified or partly equivalently substituted; and the modification or substitution should be considered within the spirit and protection scope of the present invention.

1. A method for concurrency control in a docbase management system, wherein, document data is stored in a tree structure; the method comprises:
determining whether an operation instruction on at least one node in the tree structure is compatible with every operation being implemented in the tree structure, when the operation instruction is received;
implementing the operation instruction when it is determined that the operation instruction is compatible with the operation being implemented; otherwise, not implementing the operation instruction.

2. The method of claim 1, wherein, determining whether an operation instruction on at least one node in the tree structure is compatible with every operation being implemented in the tree structure comprises:
determining whether the operation instruction on a current node is compatible with every operation being implemented in the tree structure by a compatibility matrix.

3. The method of claim 2, wherein, determining whether the operation instruction on a current node is compatible with every operation being implemented in the tree structure by a compatibility matrix comprises:
determining whether the operation instruction on a current node is compatible with the operations being implemented on its father node, ancestor nodes, son nodes and grandson nodes.

4. The method of claim 3, wherein, determining whether the operation instruction on a current node is compatible with the operations being implemented on its father node and ancestor nodes father node comprises:
determining whether the operation instruction for any of reading, writing and deleting on the current node is compatible with any of reading, writing and deleting operation that being implemented on the current node, wherein, the operation instruction for reading is compatible with the reading operation being implemented, and other operations are not compatible with each other;
determining whether the operation instruction for any of reading, writing and deleting on the current node is compatible with any of reading, writing and deleting operation that is being implemented on its father node, wherein, the operation instruction for reading is compatible with the reading operation and the writing operation that being implemented on its father node, and other operations are not compatible with each other;
determining whether the operation instruction for any of reading, writing and deleting on the current node is compatible with any of reading, writing and deleting operation that being implemented on its ancestor nodes, wherein, the operation instruction for deleting is not compatible with the reading, writing and deleting operation that being implemented on its current node, and other operations are compatible with each other.

5. The method of claim 1, further comprising:
preventing incompatible operations from being implemented by using a lock mechanism.

6. The method of claim 5, wherein, preventing incompatible operations from being implemented by using a lock mechanism comprises:
acquiring a lock of at least one node only when the operation instruction is compatible with every operation being implemented in the system;
implementing the operation instruction on at least one node only when the lock of at least one node is acquired;
releasing the lock of at least one node after the operation instruction is implemented.

7. The method of claim 6, further comprising:
defining concurrency control data of the tree structure which includes concurrency control data of each node in the tree structure;
wherein, acquiring the lock of at least one node comprises:
acquiring the lock of at least one node with reference to the concurrency control data of each of at least one node; and
releasing the lock of at least one node comprises:
releasing the lock of at least one node with reference to the concurrency control data of each of at least one node.

8. The method of claim 5, wherein, the operation instruction comprises querying/modifying operation status of at least one node, and
preventing incompatible operations from being implemented by using a lock mechanism comprises:
acquiring a status lock of at least one node when the operation instruction is compatible with every operation being implemented in the tree structure;
recording operation status of at least one node after acquiring the status lock of at least one node;
releasing the status lock of at least one node;
implementing the operation instruction of querying/modifying the operation status of at least one node;
acquiring the status lock of at least one node;
restoring the operation status of at least one node according to the operation status recorded;
releasing the status lock of at least one node.

9. The method of claim 6, wherein, when at least one node comprises more than one node,
ranking locks of more than one node in advance; and
acquiring or releasing the locks of more than one node in sequence.

10. The method of claim 9, wherein, more than one node is ranked in a total order.

11. The method of claim 6, further comprising:
acquiring the lock again after a period of waiting when it fails to acquire the lock.

12. The method of claim 11, further comprising:
transmitting node information to a deadlock releasing process/thread when failure times of acquiring a lock exceed a preset threshold;
releasing a session which holds the lock to be acquired, and the lock, when the session is determined as unresponsive by the deadlock releasing process/thread;
wherein, the deadlock releasing process/thread is activated at regular time or activated manually, or by receiving information from other process/thread, to scan each existing session in the system, determine whether the session is unresponsive, release those unresponsive sessions and further release the locks of the nodes held by those unresponsive sessions.

13. The method of claim 6, further comprising:
establishing a deadlock releasing process/thread;
wherein, the deadlock releasing process/thread is activated at regular time or activated manually, or by receiving information from other process/thread, to scan each existing session in the system, determine whether the session is unresponsive, release those unresponsive sessions and further release the locks of the nodes held by those unresponsive sessions.

14. The method of claim 13, wherein, the method for determining whether the session is unresponsive comprises:
determining the session unresponsive if the implementing time of an operation instruction in the session is beyond a preset threshold.

15. The method of claim 14, wherein, at least one interface is provided by the docbase management system, and the operation instructions are sent to the docbase management system via the at least one interface;
the method further comprises:
presetting a time threshold for each interface, and establishing a common data structure for recording information related to the operation instructions;
recording information related to an operation instruction in the common data structure before the operation instruction is implemented, when the operation instruction has been received and the lock of corresponding node has been successfully acquired;
clearing the information after the operation instruction is implemented;
wherein, the method for determining whether the session is unresponsive comprises:
determining the session as unresponsive if the implementing time of the operation instruction in the session is beyond a preset threshold according to the information recorded in the common data structure.

16. The method of claim 7, wherein, concurrency control data of each node in the tree structure comprises:
operating status, count of reading operations and count of operations on son nodes of each node; wherein,
the operating status comprises: reading status, writing status and deleting status;
the count of reading operations is used to count the times of reading operations being implemented on each node;
the count of operations on son nodes is used to count the times of operations being implemented on son nodes of each node.

17. The method of claim 16, wherein, concurrency control data of the tree structure further comprises: global concurrency control data occupied by every node; and the global concurrency control data comprises: concurrency control data of every node in the tree structure and a global lock; wherein, the global lock is used to control the access to the concurrency control data of every node in the tree structure;
wherein, acquiring the lock of at least one node comprises: acquiring the lock of each node with reference to the global concurrency control data and the concurrency control data of each node;
releasing the lock of at least one node comprises: acquiring the lock of each node with reference to the global concurrency control data and the concurrency control data of each node.

18. The method of claim 17, wherein, acquiring the lock of each node comprises:
a) acquiring the global lock to obtain access to the current concurrency control data of each node in the tree structure;
b) determining whether the count of operations on son nodes of a current node is zero if the operation being implemented on the current node is a deleting operation; continuing with Step c) if it is zero; otherwise, continuing with Step e); continuing with Step c) if the operation being implemented on the current node is not a deleting operation;
c) determining whether the operation instruction of the current node is compatible with that being implemented on the father node and ancestor nodes; continuing with Step d) if it is compatible; otherwise, continuing with Step e).
d) setting the concurrency control data of the current node, which comprises: setting operating status as the operation being implemented on the current node; adding one to the count of reading operations if the operation being implemented on the current node is a reading operation;
setting the concurrency control data of the father node of the current node, which comprises: setting operating status as a writing operation; adding one to the count of operations on son nodes;
setting the concurrency control data of the ancestor nodes of the current node, which comprises: adding one to the count of operations on son nodes;
e) releasing the global lock; and/or releasing the lock of each node comprises:
f) acquiring the global lock to obtain access to the concurrency control data of each node in the tree structure;
g) setting the concurrency control data of a current node, which comprises: clearing operating status if the operating status is a writing operation or a deleting operation; subtracting one from the count of reading operations if the operating status is a reading operation; clearing the operating status if the count of reading operations becomes zero;
setting the concurrency control data of the father node of the current node if the current node has the father node, which comprises: subtracting one from the count of operations on son nodes of the current node; clearing the operating status if the operation on the current node is a deleting operation;
setting concurrency control data of an ancestor node of the current node if the current node has the ancestor node, which comprises: subtracting one from the count of operations on son nodes;
h) releasing the global lock.

19. The method of claim 7, wherein, data types of the document data comprises: a directory, document, data segments consisted of a document, ACL data, permissions of ACL data, role data; wherein, the ACL data is adopted to describe permissions of a document/directory, each permission of the ACL data is used to describe a permission on the document/directory of a certain role;
types of nodes in the tree structure comprises: containers and flows; wherein, the root node and internal nodes are containers, and leaf nodes are containers or flows;
the method for mapping document data to an abstract tree structure comprises: mapping a directory to a container; mapping a document to a container or a flow; mapping a data segment to a container or a flow; mapping ACL data to a container or a flow; mapping the ACL permission to a flow; mapping a list of ACL data, used as a list of all the permissions, to a container; mapping role data to a container or a flow; mapping the role data, used as a list of all the roles, to a container.

20. The method of claim 3, wherein, determining whether the operation instruction on a current node is compatible with that being implemented on its father node and ancestor nodes comprises any of:
determining a specific writing operation or an attribute writing operation on each node appointed by the operation instruction is compatible with a deleting operation on its son nodes;
determining the operation instruction is not compatible with operations being implemented in the tree structure as long as one node is being operated in the paths consisting of the current node appointed by the operation instruction, its father node, ancestor nodes and son nodes;
determining the operation instruction is compatible with a deleting operation on the father node of each node appointed by the operation instruction.
